(19) United States
(12) Patent Application Publication
(10) Pub. No.: US 2025/0173049 A1
(43) Pub. Date: May 29, 2025

(54) INFORMATION DISPLAYING METHOD, APPARATUS AND ELECTRONIC DEVICE

(71) Applicant: Beijing Zitiao Network Technology Co., Ltd., Beijing (CN)

(72) Inventors: Yueying WANG, Beijing (CN); Xin XIE, Beijing (CN); Bowen SHEN, Beijing (CN); Zhaoyuan PENG, Beijing (CN); Yongqiang ZHAO, Beijing (CN)

(21) Appl. No.: 18/840,872

(22) PCT Filed: Feb. 23, 2023
(86) PCT No.: PCT/CN2023/077960

§ 371 Date: Aug. 22, 2024

(30) Foreign Application Priority Data
Feb. 24, 2022 (CN) 202210174491.6

(51) Int. Cl. G06F 3/0484

(52) U.S. Cl. CPC G06F 3/0484

(57) ABSTRACT

Embodiments of the disclosure provide an information displaying method, apparatus and electronic device. The method comprises: in response to a first predetermined condition being satisfied, obtaining, for a first entity associated with a first session to which a first user belongs, predetermined information of a second session associated with the first entity; and displaying information of the first session in an interface of the first user and displaying, in association, the predetermined information of the second session in the interface of the first user. Therefore, the user, while browsing the information of the first session, can learn about the information of the second session, which helps the user to process the information of the second session as soon as possible and enhances the information interaction efficiency.

### CROSS REFERENCE TO RELATED APPLICATIONS

This application claims priority to Chinese Patent Application No. 202210174491.6, filed with the Chinese Patent Office on Feb. 24, 2022 and entitled “information displaying method, apparatus and electronic device”, the disclosures of which are incorporated herein by reference in their entities.

### FIELD

The present disclosure relates to the field of Internet and software technology, and in particular, to an information displaying method, apparatus and electronic device.

### BACKGROUND

Users can perform information interaction in real time through the Internet, for example, performing information exchange using instant messaging applications.

Current modes of information interaction can include one-on-one chat sessions and group chat sessions. In the interface of an instant messaging application, usually one-on-one chat sessions and group chat information sessions can be displayed in the form of session information streams. The information of each one-on-one chat or group chat session can be displayed in an information display region of the one-on-one chat or group chat session.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the present disclosure provide an information displaying method, apparatus and electronic device.

In a first aspect, the embodiments of the present disclosure provide an information displaying method. The method comprises: in response to a first predetermined condition being satisfied, obtaining, for a first entity associated with a first session to which a first user belongs, predetermined information of a second session associated with the first entity: and displaying information of the first session in an interface of the first user and displaying, in association, the predetermined information of the second session in the interface of the first user.

In a second aspect, the embodiments of the present disclosure provide an information displaying apparatus. The apparatus comprises: an obtaining unit configured for, in response to a first predetermined condition being satisfied, obtaining, for a first entity associated with a first session to which a first user belongs, predetermined information of a second session associated with the first entity: and a displaying unit configured for displaying information of the first session in an interface of the first user and displaying, in association, the predetermined information of the second session in the interface of the first user.

In a third aspect, the embodiments of the present disclosure provide an electronic device, comprising: one or more processors: a storage unit for storing one or more programs which, when executed by the one or more processors, cause the one or more processors to implement the information displaying method as described in the first aspect.

In a fourth aspect, the embodiments of the present disclosure provide a computer readable medium, storing a computer program thereon. The program, when executed by a processor, implement steps of the information displaying method as described in the first aspect.

### BRIEF DESCRIPTION OF THE DRAWINGS

Through the more detailed description of detailed implementations with reference to the accompanying drawings, the above and other features, advantages and aspects of respective embodiments of the present disclosure will become more apparent. The same or similar reference numerals represent the same or similar elements throughout the figures. It should be understood that the figures are merely schematic, and components and elements are not necessarily drawn scale.

FIG. 1 is a flowchart of an information displaying method according to some embodiments of the present disclosure:

FIG. 2 illustrates a schematic display interface of information of a first session:

FIG. 3 illustrates a schematic diagram of information of a multi-entity first session;

FIG. 4 is a structural schematic diagram of an information displaying apparatus according to an embodiment of the present disclosure:

FIG. 5 is an example system architecture in which an information displaying method of an embodiment of the present disclosure may be applied; and

FIG. 6 is a schematic diagram of a basic structure of an electronic device provided by the embodiments of the present disclosure.

### DETAILED DESCRIPTION

The embodiments of the present disclosure will be described in more detail with reference to the accompanying drawings, in which some embodiments of the present disclosure have been illustrated. However, it should be understood that the present disclosure can be implemented in various manners, and thus should not be construed to be limited to embodiments disclosed herein. On the contrary, those embodiments are provided for the thorough and complete understanding of the present disclosure. It should be understood that the drawings and embodiments of the present disclosure are only used for illustration, rather than limiting the protection scope of the present disclosure.

It should be understood that various steps described in method implementations of the present disclosure may be performed in a different order and/or in parallel. In addition, the method implementations may comprise an additional step and/or omit a step which is shown. The scope of the present disclosure is not limited in this regard. The term “comprise” and its variants used here are to be read as open terms that mean “include, but is not limited to.” The term “based on” is to be read as “based at least in part on.” The term “one embodiment” are to be read as “at least one embodiment.” The term “another embodiment” is to be read as “at least one other embodiment.” The term “some embodiments” are to be read as “at least some embodiments.” Other definitions will be presented in the description below.

Note that the concepts “first,” “second” and so on mentioned in the present disclosure are only for differentiating different apparatuses, modules or units rather than limiting the order or mutual dependency of functions performed by these apparatuses, modules or units.

Note that the modifications “one” and “a plurality” mentioned in the present disclosure are illustrative rather than limiting, and those skilled in the art should understand that unless otherwise specified, they should be understood as “one or more”.

Names of messages or information interacted between a plurality of apparatuses in the implementations of the present disclosure are merely for the illustration purpose, rather than limiting the scope of these messages or information.

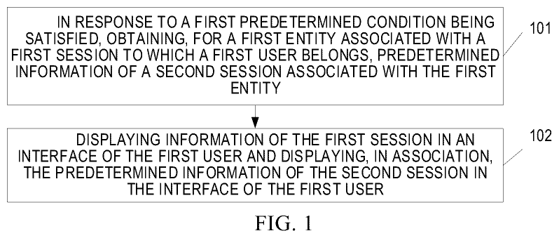

With reference to FIG. 1, this figure shows a flow of an information displaying method according to an embodiment of the present disclosure. The information displaying method as shown in FIG. 1 comprises the following:

Step 101, in response to meeting a first predetermined condition, for a first entity associated with a first session to which a first user belongs, obtaining preset information of a second session associated with the first entity.

Step 102, displaying information of the first session in an interface of the first user, and displaying, in an associated manner, the preset information of the second sessions in the interface of the first user.

Here, the first session and the second session each may be a group chat session or a one-on-one chat session. The first user here can be a participant in the first session.

In some application scenarios, the second session does not include the first session. In these application scenarios, the second session is other session than the first session associated with the first entity.

In these application scenarios, when the first predetermined condition is met, the preset information of the second session is displayed in association with the information of the first session. This can increase the information transfer efficiency.

In some other application scenarios, the second session comprises the first session and other session. That is, when the first predetermined condition is met, besides displaying the information of the first session, the preset information of the second session comprising the first session and other session is further displayed. Information of other session can be learned from the preset information. This achieves the effect of displaying information of other session while displaying the information of the first session.

In some other application scenarios, the second session comprises a session having a specific attribute and associated with the first entity.

As one implementation, when the preset information of the second session comprises information on an unread message in the second session, the specific attribute here may be, for example, an attribute for notification of an unread message. Specifically, the session with the specific attribute may be a session for notification of an unclosed message.

In such an implementation, when the second session has the attribute for notification of an unread message, in response to meeting the first predetermined condition, information on an unread message of the second session may be displayed at the same time while displaying the session information of the first session. Therefore, it is possible to prompt in time that the second session belonging to the first entity together with the first session has an unread message.

As another implementation, the specific attribute here may be, for example, an important session attribute. In such an implementation, the second session may be a session other than the first session.

In response to meeting the first predetermined condition, while displaying the session information of the first session, preset information of the important second session may be displayed at the same time, so as to display to the user in time that the important second session has the preset information.

In some other application scenarios, the second session comprises the first session and other session.

In some application scenarios, the first entity may be a team. The team here is a concept in instant messaging application scenarios, and specifically, the team may be associated with at least one session. The team and team members associated with the team may perform information interaction in a group session in which they participate. Here, the group session in which team members participate refer to a session associated with the team. A set of session members of the session associated with the team may be a subset of a set of team members, or may comprise team members and non-team members.

In some other application scenarios, the first entity may further be an organization (e.g., a department, company), and the first user belongs to the organization. The organization may be associated with a plurality of sessions. Optionally, all participants of a plurality of sessions associated with the organization belong to the organization.

In some other application scenarios, the first entity may be a main group including at least one subgroup. In these application scenarios, there is no limitation on the constraint relationship between the group member set of the subgroup and the group member set of the general group.

In some application scenarios, the first predetermined condition here may be that the first session meets a first specified condition.

As one implementation, the first specified condition here includes: a new message being received in the first session.

In these implementations, the execution body of the information displaying method may obtain the predetermined information of the second session when detecting receipt of a new message of the first session.

The execution body of the above information displaying method may be the user's terminal. When detecting that the first session receives a new message, the terminal may initiate to the server to obtain the predetermined information of the second session associated with the first entity.

There is no limitation on the setting of the message notification status of the first session here. For example, the new message notification of the first session can be in on status or in off status.

In these implementations, when detecting that the first session receives a new message, the predetermined information of the second session can be obtained and displayed, which can improve the real-time performance of message display.

As one implementation, receiving a new message in the first session includes: the first session is not excluded from the session streaming region and a new message is received in the first session.

The message notification status for a session may be set. The message notification status of a session includes on status and off status. If the message notification status of a session is turned on, when the session receives a new message, the dynamics of the session can be displayed in the session streaming region. If the message notification of a session is turned off, when the session receives a new message, the dynamics of the session do not need to be displayed in the session streaming region. The first session is not excluded from the session streaming region, which means that the message notification of the first session is in on status.

In this implementation, the session streaming region usually displays the information of each session from top to bottom in reverse chronological order of receiving times of new messages. Session information for a session that receives a new message recently is usually displayed at the top of the session streaming region.

That is, when the message notification of the first session is in on status and a new message is received in the first session, the predetermined information of the second session can be obtained. In this implementation, the predetermined information of the second session can be updated synchronously when the information of the first session is updated.

As another implementation, the first specified condition here includes: displaying the first session in the session streaming region according to a user instruction. The user instruction here includes, for example, displaying the first session in the session streaming region through a search instruction.

In these implementations, when the execution body detects that the first session is displayed in the session streaming region in the first session according to the user instruction, the execution body may initiate to the server to obtain predetermined information of the second session associated with the first entity.

In some other application scenarios, the first predetermined condition may include that the second session meets a second specified condition.

As one implementation, the second specified condition includes that the predetermined information of the second session is updated.

In this implementation, when the predetermined information of the second session is updated, the server may send to the user terminal notification information that the predetermined information of the second session is updated. The terminal may obtain the predetermined information of the second session from the server according to the notification information.

Additionally, in this implementation, information of the first session may be displayed in the session streaming region.

When the information of the first session is displayed in the session streaming region, if the predetermined information of the second session is updated, the predetermined information of the second session can be obtained and displayed in the session streaming region, so that the updated predetermined information of the second session can be displayed in time.

The predetermined information of the second session here may include, but is not limited to, one or more of: unread message-related information in the second session: task-related information in the second session: online and/offline file-related information in the session: and schedule-related information in the second session.

In some application scenarios, the predetermined information of the second session includes the unread message-related information in the second session.

If the second session does not include the first session, the unread message-related information in the second session may be unread message-related information corresponding to other session associated with the first entity than the first session.

If the second session includes the first session, the unread message-related information of the second session may be unread message-related information corresponding to a plurality of associated with the first entity including the first session.

The unread message-related information may include at least one of: an identifier indicating that the session has an unread message and the number of unread messages.

By displaying the unread message-related information of the second session, the user is prompted to process the unread message, which helps to shorten the path or duration for the user to process the unread message.

In some other application scenarios, the predetermined information of the second session includes task-related information.

The task here can be, for example, a to-do item created and/or sent in a session. If the second session includes a plurality of sessions, the task-related information may be statistical information of to-do items corresponding to the plurality of sessions respectively.

In some other application scenarios, the predetermined information of the second session includes online and/or offline document-related information.

The online and/or off document may be a document sent within the session. Each online document can be located in the session corresponding to the online document. Each offline document can be located in the session corresponding to the offline document.

If the second session includes a plurality of sessions, the online and/or offline document-related information here may be statistical information of online and/or offline documents corresponding to the plurality of sessions respectively.

In some other application scenarios, the predetermined information of the second session includes schedule-related information created and/or sent in the second session.

The schedule of each session may be different. If the second session includes a plurality of sessions, the predetermined information of the second session may be the statistical information of schedules corresponding to the plurality of sessions respectively.

In some optional implementations, when the predetermined information of the second session includes unread message-related information in the second session, the unread message-related information in the second session includes one or more of: information indicating the total number of unread messages in all second sessions: identification information “mentioned me (@me)” and/or identification information “mentioned all (@everyone)”.

In some application scenarios, the unread message-related information in the second session includes information indicating the total number of unread messages in the second session.

If the second session does not include the first session, the total number of unread messages may be the total number of unread messages in other sessions associated with the first entity except the first session.

Alternatively, the total number of unread messages may be the total number of unread messages of other sessions associated with the first entity and whose message notification status is on.

If the second session includes the first session, the total number of unread messages may be the total number of unread messages corresponding to a plurality of sessions associated with the first entity, or may be the total number of unread messages corresponding to a plurality of sessions associated with the first entity and whose message notification status is on.

The information indicating the total number of unread messages in the second session may include the number of unread messages. In addition, the information indicating the total number of unread messages in the second session may also be information indicating that the unread messages are above a certain value. For example, if the number of unread messages is greater than 100, the information about the total number of unread messages may be “100+”, which indicates that the total number of unread messages is greater than 100.

In some application scenarios, the unread message-related information of the second session includes identification information indicating “mentioned me” and/or identification information indicating “mentioned all”.

In these application scenarios, the unread message-related information in the second session may also include quantity information of “mentioned me” identification information and/or “mentioned all” identification information.

In these application scenarios, displaying the identification information and the quantity information corresponding to the identification information in the unread message-related information of the second session can enable the user to quickly learn about unprocessed messages that “mentioned me” and/or “mentioned all” in the second session.

In some optional implementations, obtaining the predetermined information of the second session associated with the first entity in step 101 comprises: sending an information obtaining request to the server, where the information obtaining request comprises an identifier of the first entity and/or an identifier of the first session: receiving the predetermined information of the second session associated with the first entity sent by the server according to the information obtaining request.

In some application scenarios, the information obtaining request may include the identifier of the first entity. The server stores respective information of a plurality of sessions associated with the first entity and statistical information of the respective information of the plurality of sessions. The information of a session comprises one or more of: unread message-related information in the session: task-related information in the session: online and/or offline document-related information in the session; and schedule-related information in the session.

That is, the server stores information on a plurality of sessions associated with the first entity. Statistics will be made on the information of the plurality of sessions associated with the first entity, for example, counting the total number of unread messages corresponding to a plurality of sessions associated with the first entity, or a plurality of sessions that meet the predetermined condition, and counting the total number of unread messages of other sessions associated with the first entity except the first session; counting the total number of tasks corresponding to a plurality of sessions associated with the first entity, counting the total number of tasks of other sessions associated with the first entity except the first session: counting the number of online and/or offline documents corresponding to a plurality of sessions associated with the first entity, count the number of online and/or offline documents of other sessions associated with the first entity except the first session; count the number of schedules corresponding to a plurality of sessions associated with the first entity, and counting the number of schedules of other sessions associated with the first entity except the first session, etc.

In other application scenarios, the information obtaining request may include the identification of the first session. The server may search for one or more first entities associated with the first session based on the identifier of the first session, and then determine the second session associated with the first entity based on the first entity. Thus, the above information of the second session is collected.

After receiving the information obtaining request, the server may send the statistical results to the client as predetermined information of the second session, so that the client can display the information of the second session in association with the information of the first session.

In some application scenarios, in step 102, the predetermined information of the second session may be displayed in a display region that displays information of the first session.

In some other application scenarios, the information of the first session and the predetermined information of the second session can be displayed respectively in display regions of different sessions in interface of the first user.

By means of the information displaying method provided in this embodiment, in response to meeting a first predetermined condition, for a first entity associated with a first session to which a first user belongs, preset information of a second session associated with the first entity is obtained: and information of the first session is displayed in an interface of the first user, and the preset information of the second session is displayed, in an associated manner, in the interface of the first user. Therefore, the user, while browsing the information of the first session, can learn about the information of the second session belonging to the first entity together with the first session, which helps the user to process the information of the second session as soon as possible.

In some other embodiments, the information of the first session displayed in the interface of the first user in step 102 further comprises: a first identifier used to indicate a subordinative relationship between the first session and the first entity.

In these embodiments, the information of the first session may comprise a first session identifier, a first entity identifier, and a first identifier used to indicate a subordinative relationship between the first session and the first entity.

Through the above identifiers, the user can clearly understand the subordinative relationship between the first session and the first entity.

Specifically, the identifier of the first session may include a profile picture of the first session and a name of the first session. The identifier of the first entity may include a name of the first entity. That is, the information of the first session may include the profile picture of the first session, the name of the first session, and the name of the first entity. The first identifier may be used to represent the association between the profile picture of the first session and the name of the first entity.

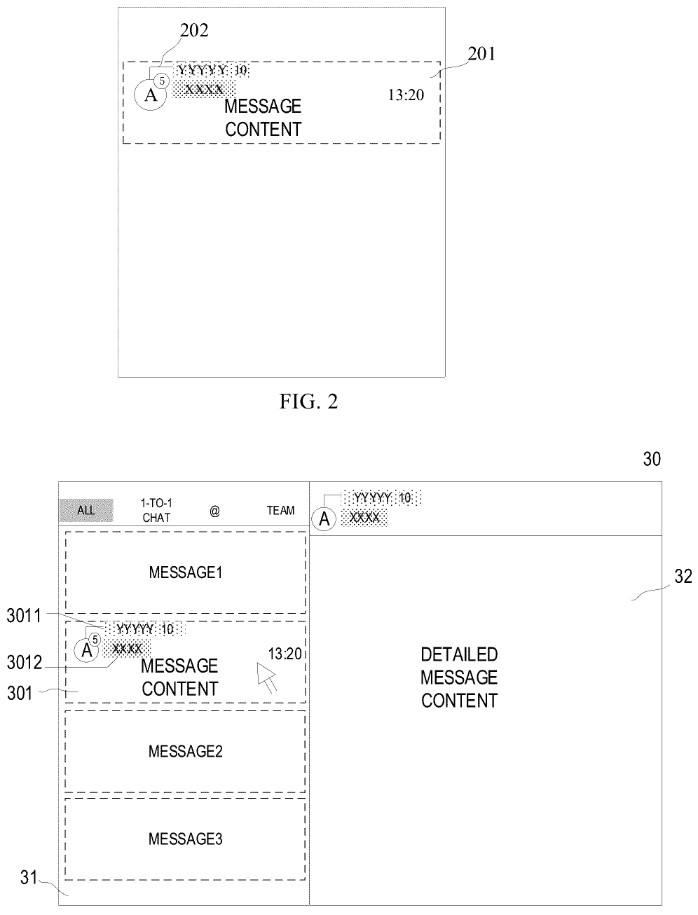

With reference to FIG. 2, this figure shows a schematic diagram of an application scenario of the information displaying method. As shown in FIG. 2, when the first predetermined condition is met, by obtaining the information of the second session, the predetermined information of the second session associated with the first entity is displayed in an associated manner when the information of the first session associated with the first entity is displayed. An information display region 201 of the first session may display the name of the first session “XXXX”, the profile picture of the first session, and the number of unread messages of the first session “5”. The name “YYYYY” of the first entity may be displayed in the information display region of the first session. The predetermined information of the second session may be displayed near the name of the first entity. The predetermined information of the second session here may be the total number of unread messages “10” in a plurality of sessions associated with the first entity. The second session here may or may not include the first session.

In addition, the information display region 201 of the first session may further display a first identifier 202 of the subordinative relationship between the first session and the first entity. The first session identifier includes a profile picture of the first session and a name of the first session. The first entity identifier includes a name of the first entity. The first identifier 202 is set between the profile picture of the first session and the name of the first entity, so that the user can clearly see the association between the first session and the first entity. In addition, the information display region 201 of the first session also includes a message content display region, which is used to display at least part of content of a recently received message.

In some other embodiments, the information of the first session displayed in the interface of the first user in step 102 further comprises: displaying information of the first session in a session information display region in a session streaming region of an instant messaging client interface of the first user: wherein the name information of the first entity and the predetermined information of the second session are displayed in a first sub-region of the session information display region.

In these embodiments, the name information of the first entity and the predetermined information of the second session are displayed in the session information display region of the first session. Therefore, the user can browse the predetermined information of the second session associated with the first entity in the first session display region, thereby learning information of other sessions associated with the first entity.

In some application scenarios, the predetermined information of the second session may include one or more of unread message-related information, task-related information, schedule-related information, and document-related information of the second session. The unread message-related information may include the number of unread messages: the task-related information may include the number of tasks to be done: the schedule-related information may include schedule information to be processed: the document-related information may include the number of documents in the second session, etc. By putting the unread message-related information, task-related information, schedule-related information, and document-related information of the second session together with the name of the first entity, it is possible for the user to easily understand that the predetermined information is related to the first entity (session associated with the entity), not just to the current first session.

In some application scenarios, the session streaming region of the instant messaging client interface may have a plurality of session filtering tags. When the session streaming region of the instant messaging client interface has a plurality of session filtering tags, displaying the information of the first session in the interface of the first user comprises: in the instant messaging client interface of the first user, when a session filtering tag corresponding to a first filtering condition is selected, displaying the information of the first session in a session information display region in the session streaming region.

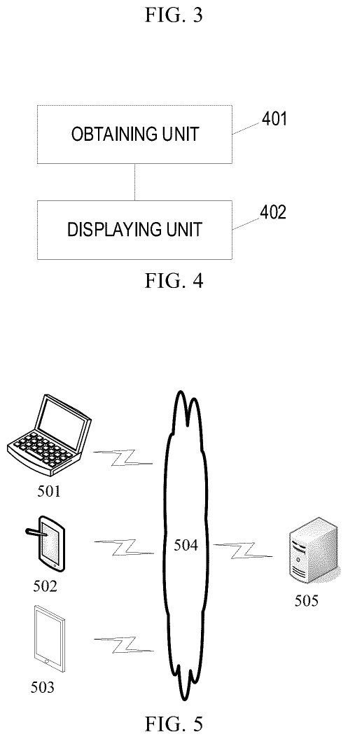

As shown in FIG. 3, an instant messaging client interface 30 may include a plurality session filtering tags, such as an “all” tag used to indicate the main session stream, a “one-on-one chat” tag used to indicate a one-on-one chat session, and an “@” tag used to indicate that the first user was mentioned in information, and a “team” tag used to indicate that the session is a team session. Each session filtering tag corresponds to a predetermined filtering condition. The filtering condition of a session filtering tag is used to filter out at least one session that meets the filtering condition from a plurality of sessions. Take the “one-on-one chat” session filtering tag as an example. The filtering condition is “sessions in which two people chat alone.” The filtering condition corresponding to the “all” tag (that is, the main session stream filtering tag) is all sessions.

When the first session meets the first filtering condition, and when the session filtering tag corresponding to the first filtering condition is selected, the information of the first session can be displayed in a session information display region in the session streaming region.

In some application scenarios, the above-mentioned first filtering condition includes a filtering condition that filters out all sessions. In these application scenarios, the above-mentioned session filtering label corresponding to the first filtering condition is the main session stream filtering tag “all”. In some other application scenarios, the above-mentioned first filtering condition may be a filtering condition for filtering out sessions with unread messages. In these application scenarios, the above-mentioned session filtering tag corresponding to the first filtering condition is the session filtering tag “unread” used to indicate that the session has an unread message.

Taking the main session stream filtering tag as an example, when the main session stream filtering tag “all” is selected, all session streams related to the first user can be displayed in the session streaming region. All session streams here may include information about sessions corresponding to a plurality of other filtering tags.

When the main session stream filtering tag “all” is selected, a plurality of session streams may be displayed in the session streaming region 31 in the instant messaging client interface 30. Each session stream can occupy a certain size of session information display region. The information of the first session may be displayed in a session information display region of the session stream.

Further, a session information display region 301 of the first session may include a first sub-region 3011 and a second sub-region 3012. The name information “YYYYY” of the first entity is displayed in the first sub-region, and the name information “XXXX” of the first session is displayed in the second sub-region 3102. In some application scenarios, the first sub-region 3011 and the second sub-region 3012 are located in different rows.

In addition, graphic or image information of the first session may further be displayed in the session information display region 301. For example, “\textcircled{A}” in FIG. 3 is the graphic information of the first session. The quantity information of unread messages corresponding to the first session may be displayed at a predetermined location of the graphic or image information of the first session. As shown in FIG. 3, the “5” in the upper right corner of “\textcircled{A}” means that the first session “XXXX” has 5 unread messages. In addition, the information of the second session can also be displayed in the first sub-region. The information of the second session here includes unread messages corresponding to the second session. As shown in FIG. 3, in the first sub-region 3011, “10” displayed on the right side of the first entity's name information “YYYYY” identifies that the first entity “YYYYY” corresponds to 10 unread messages.

In these application scenarios, displaying the name information of the first session and the name information of the first entity in separate lines helps the user to quickly identify the name of the first session and the name of the first entity in the information of the first session.

In some other application scenarios, the first sub-region and the second sub-region jointly occupy a specified number of lines and are separated by special symbols.

In these application scenarios, in order to reduce the space occupied by the name information of the first session and the name information of the first entity, it may be set that the first sub-region and the second sub-region jointly occupy a specified number of lines. In order to facilitate the differentiation between the name information of the first session and the name information of the first entity, special symbols may be set between the first sub-region and the second sub-region for separation. The special symbols here can be any predetermined symbols. As a schematic illustration, the above-mentioned special symbols may be, for example, “|”, “>”, etc.

It should be noted that the session information display region 301 of the first session also includes other sub-regions, such as a region for displaying the avatar of the first session, a region for displaying the latest message in the first session, etc. The region displaying the latest message may display at least part of the message content of the latest received message.

Further, the user can trigger the information of the first conversation, thereby triggering the display of detailed message content of the information of the first conversation. As shown in FIG. 3, when the first user clicks on the session information display region 301 of the first session, the first user can trigger the display of the detailed message content of the first session in the session message content display region 32 of the instant messaging client interface 30.

In some embodiments, the first session can be associated with one first entity or more than two first entities. If the first session is associated with more than two first entities, the above step 101 may include: in response to satisfying the first predetermined condition, determining a target first entity from the more than two first entities: and for the target first entity, obtaining predetermined information of a second session associated with the target first entity.

That is, when the first predetermined condition is satisfied, the target first entity is first determined from the more than two first entities, and then the predetermined information of the second session associated with the target first entity is obtained and displayed.

Further, the determining a target first entity from the more than two first entities comprises: determining at least one target first entity from the more than two first entities based on a second predetermined condition.

In some application scenarios, the above-mentioned second predetermined condition includes: the frequency at which information of other sessions associated with the first entity is browsed by the first user is greater than a predetermined frequency threshold.

That is to say, if other session than the first session of one of the first entities is frequently browsed by the first user, then the first entity may be determined as the target first entity.

The first entity whose associated other sessions are browsed more frequently by the first user means that the first user interacts with the first entity more frequently and is highly desirable to quickly understand the development of the first entity.

Since the first entity whose associated other sessions are browsed by the first user at a higher frequency is determined as the target first entity, when the information of the first session is displayed, the second session information of the target first entity can be simultaneously displayed in association, which helps to improve the user experience.

In some other application scenarios, the above-mentioned second predetermined condition includes: a message notification attribute of other sessions associated with the first entity is set to notification.

In these application scenarios, if the message notification attribute of a first entity's other sessions than the first session is notification, it means that new messages of the other sessions need to be notified. Since the first entity whose associated other sessions have a message notification attribute of notification is determined as the target first entity, when the information of the first session is displayed, the information of the second session of the target first entity is simultaneously displayed in association, which helps to improve the delivery rate of notification of new messages of other sessions associated with the first entity.

In some other embodiments, the above information displaying method further comprises: in response to an operation of triggering the predetermined information of the second session, displaying the information associated with one or more first entities associated with the first session in a first specified region in the first user's interface.

The information of the first entity associated with the first session includes: identification information of the first entity and information of respective sessions associated with the first entity.

In these embodiments, the operation of triggering the predetermined information of the second session includes performing a selection operation such as clicking and touching on the predetermined information of the second session.

In some application scenarios, the first specified region may be, for example, an original information stream display region. That is, after the predetermined information of the second session is triggered, the display content of the original information stream display region can be switched to the information of one or more first entities associated with the first session.

In some other application scenarios, the above-mentioned first specified region may also be a detailed message content display region 32 that displays detailed message content as shown in FIG. 3.

In some application scenarios, the information of one or more first entities associated with the first session may include, for example, information of unread messages, task information, schedule information and document information corresponding to one or more first entities.

In some application scenarios, after the predetermined information of the second predetermined session is triggered, the information of one or more first entities that satisfy the second predetermined condition may be displayed in the above-mentioned first specified region.

In these embodiments, the user can browse the information of the first entity by triggering the predetermined information of the second session. This allows the user to quickly browse the information of the first entity when browsing the first session, thereby saving the user's time.

With further reference to FIG. 4, as an implementation of the methods shown in the above figures, the present disclosure provides an embodiment of an information displaying apparatus. The apparatus embodiments correspond to the method embodiments shown in FIG. 1. Specifically, the apparatus can be applied to various electronic devices.

As shown in FIG. 4, the information displaying apparatus in this embodiment comprises: an obtaining unit 401 and a displaying unit 402, wherein the obtaining unit 401 is configured for, in response to a first predetermined condition being satisfied, obtaining, for a first entity associated with a first session to which a first user belongs, predetermined information of a second session associated with the first entity: and the displaying unit 402 is configured for displaying information of the first session in an interface of the first user and displaying, in association, the predetermined information of the second session in the interface of the first user.

In this embodiment, the specific processing of the obtaining unit 401 and the displaying unit 402 of the information displaying apparatus and the technical effects thereof can be referred to the relevant descriptions of steps 101 and 102 in the corresponding embodiments in FIG. 1, which will not be repeated here.

In some optional implementations, the second session does not comprise the first session: or the second session comprises the first session and other sessions.

In some optional implementations, the predetermined information of the second session comprises one or more of: unread message-related information in the second session: task-related information in the second session; online document and/or offline file-related information in the second session; and schedule-related information in the second session.

In some optional implementations, the second session comprises a session with a specific attribute associated with the first entity.

In some optional implementations, when the predetermined information of the second session comprises unread message-related information in the second session, the session with a specific attribute comprises: a session in which message notification is not turned off.

In some optional implementations, when the predetermined information of the second session comprises unread message-related information in the second session, the unread message-related information of the second session comprises one or more of: information indicating the total number of unread messages in all second sessions: “mention me” identification information and/or “mention all” identification information.

In some optional implementations, the displayed information of the first session further comprises: a first identifier indicating a subordinative relationship between the first session and the first entity.

In some optional implementations, the information of the first session comprises: an avatar of the first session, a name of the first session, and a name of the first entity: the first identifier is used to characterize an association relationship between the avatar of the first session and the name of the first entity.

In some optional implementations, the displaying the information of the first session in the interface of the first user comprises: displaying the information of the first session in a session information display region in a session streaming region of an instant messaging client interface of the first use: wherein name information of the first entity and the predetermined information of the second session are displayed in a first sub-region of the session information display region.

In some optional implementations, when the session streaming region of the instant messaging client interface has a plurality of session filtering tags, the displaying the information of the first session in the interface of the first user comprises: in the instant messaging client interface of the first user, displaying the information of the first session in a session information display region in a session streaming region when a main session stream filtering tag is selected.

In some optional implementations, the displaying unit 402 is further configured for: displaying the name information of the first session in a second sub-region of the session display region: wherein the first sub-region and the second sub-region are located on different lines: or, the first sub-region and the second sub-region jointly occupy a specified number of lines and are separated by special symbols.

In some optional implementations, the first predetermined condition comprises: the first session to which the first user belongs satisfies a first specified condition: or the second session satisfies a second specified condition.

In some optional implementations, the first specified condition comprises: a new message is received in the first session, or the first session is not excluded from the main session stream and a new message is received in the first session; the second specified condition comprises: the predetermined information of the second session is updated.

In some optional implementations, the displaying unit 402 is further configured to: in response to an operation of triggering the predetermined information of the second session, displaying information of one or more first entities associated with the first session in a first specified region of the interface of the first user, wherein the information of the first entity associated with the first session comprises identification information of the first entity and information of respective sessions associated with the first entity.

In some optional implementations, the first session is associated with more than two first entities. The obtaining unit 401 is further configured for: in response to a first predetermined condition being satisfied, determining a target first entity from the more than two first entities, and for the target first entity, obtaining predetermined information of a second session associated with the target first entity.

In some optional implementations, the obtaining unit 401 is further configured for: determining at least one target first entity from the more than two first entities based on a second predetermined condition: wherein the second predetermined condition comprises one of the following: the frequency with which information of other session associated with the first entity is browsed by the first user is greater than a predetermined frequency threshold: and a message notification attribute of other session associated with the first entity is set to notification.

In some optional implementations, the obtaining unit 401 is further configured for: sending an information obtaining request to a server, the information obtaining request comprising an identifier of the first entity and/or an identifier of the first session: receiving predetermined information of a second session associated with the first entity sent by the server based on the information obtaining request:
wherein the server stores information of a plurality of sessions associated with the first entity and statistical information of the information of the plurality of sessions, respectively: information of a session comprises one or more of: unread message-related information in the session; task-related information in the session: online document and/or offline file-related information in the session: and schedule-related information in the session.

With reference to FIG. 5, the figure shows an example system architecture in which an information displaying method of an embodiment of the present disclosure can be applied.

As shown in FIG. 5, the system architecture may include terminals 501, 502 and 503, a network 504, as well as a server 505. The network 504 is a medium used to provide communication links between the terminals 501, 502, 503 and the server 505. The network 504 may include various connection types, such as wired, wireless communication links, or fiber optic cables, etc.

The terminals 501, 502, 503 can interact with the server 505 through the network 504 to receive or send messages, etc. Various client applications can be installed on the terminals 501, 502, and 503, such as web page browser applications, search applications, instant messaging applications, and news information applications. The client applications in the terminals 501, 502, and 503 can receive the user's instructions and accomplish corresponding functions according to the user's instructions, such as displaying the information stream of the instant messaging application according to the user's instructions.

The terminals 501, 502, and 503 may be hardware or software. When the terminals 501, 502, and 503 are hardware, they can be various electronic devices with display screens and supporting web page browsing, including but not limited to smartphones, tablet computers, e-book readers, MP3 (Moving Picture Experts Group Audio Layer III) players, MP4 (Moving Picture Experts Group Audio Layer IV) players, laptop portable computers and desktop computers, etc. When the terminals 501, 502, and 503 are software, they can be installed in the electronic devices listed above. They can be implemented as a plurality of software or software modules (such as software or software modules providing distributed services), or as a single software or software module, which is not limited here.

The server 505 can provide various services, such as receiving information obtaining requests sent by the terminals 501, 502, and 503, analyzing and processing the information obtaining requests, and sending analysis and processing results (such as communication information corresponding to the obtaining requests) to the terminals 501, 502, 503.

It should be noted that the information displaying method provided by the embodiments of the present disclosure can be performed by a terminal, and accordingly, the information displaying apparatus can be provided in the terminals 501, 502, and 503. In addition, the information displaying method provided by the embodiments of the present disclosure can also be performed by the server 505, and accordingly, the information displaying apparatus can be provided in the server 505.

It should be understood that the number of terminals, networks and servers in FIG. is only illustrative. There may exist any number of terminals, networks, and servers depending on implementation needs.

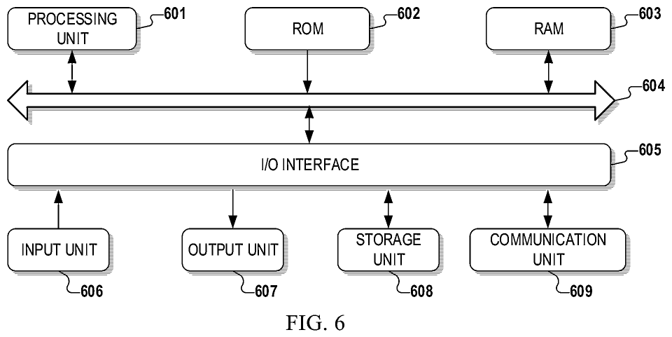

With reference to FIG. 6, this figure shows a structural schematic diagram of an electronic device which is applicable to implement the embodiments of the present disclosure. Here, the electronic device generally refers to a terminal or server in the hardware form (e.g., the terminal device or server in FIG. 5). The terminal device in the embodiments of the present disclosure may include, without limitation to, a mobile terminal such as a mobile phone, a notebook computer, a digital broadcast receiver, a PDA (personal digital assistant), a PAD (portable Android device), a PMP (portable multimedia player), an on-board terminal (e.g., an on-board navigation terminal), a wearable terminal device and the like, and a fixed terminal such as digital TV, a desktop computer, a smart home device and the like. The electronic device shown in FIG. 6 is merely an example and should not be construed as bringing any restriction on the functionality and usage scope of the embodiments of the present disclosure.

As shown in FIG. 6, the electronic device 600 may comprise a processing unit (e.g., a central processor, a graphics processor) 601 which is capable of performing various appropriate actions and processes to realize the method of table processing as described in the embodiments of the present disclosure in accordance with programs stored in a read only memory (ROM) 602 or programs loaded from a storage unit 608 to a random access memory (RAM) 603. In the RAM 603, there are also stored various programs and data required by the electronic device 600 when operating. The processing unit 601, the ROM 602 and the RAM 603 are connected to one another via a bus 604. An input/output (I/O) interface 605 is also connected to the bus 604.

Usually, the following units may be connected to the I/O interface 605: an input unit 606 including a touch screen, a touch pad, a keyboard, a mouse, a camera, a microphone, an accelerometers, a gyroscope, or the like: an output unit 607, such as a liquid-crystal display (LCD), a loudspeaker, a vibrator, or the like: a storage unit 608, such as a magnetic tape, a hard disk or the like: and a communication unit 609. The communication unit 609 allows the electronic device to perform wireless or wired communication with other device so as to exchange data with other device. While FIG. 6 shows the electronic device with various units, it should be understood that it is not required to implement or have all of the illustrated units. Alternatively, more or less units may be implemented or exist.

Specifically, according to the embodiments of the present disclosure, the procedures described with reference to the flowchart may be implemented as computer software programs. For example, the embodiments of the present disclosure comprise a computer program product that comprises a computer program embodied on a non-transitory computer-readable medium, the computer program including program codes for executing the method shown in the flowchart. In such an embodiment, the computer program may be loaded and installed from a network via the communication unit 609, or installed from the storage unit 608, or installed from the ROM 602. The computer program, when executed by the processing unit 601, perform the above functions defined in the method of the embodiments of the present disclosure.

It is noteworthy that the computer readable medium of the present disclosure can be a computer readable signal medium, a computer readable storage medium or any combination thereof. The computer readable storage medium may be, for example, but is not limited to, an electronic, magnetic, optical, electromagnetic, infrared or semiconductor system, apparatus or device, or any combination of the foregoing. More specific examples of the computer readable storage medium may include, without limitation to, the following: an electrical connection with one or more conductors, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium containing or storing a program which may be used by an instruction executing system, apparatus or device or used in conjunction therewith. In the present disclosure, the computer readable signal medium may include a data signal propagated in baseband or as part of a carrier wave, with computer readable program code carried therein. The data signal propagated as such may take various forms, including without limitation to, an electromagnetic signal, an optical signal or any suitable combination of the foregoing. The computer readable signal medium may further be any other computer readable medium than the computer readable storage medium, which computer readable signal medium may send, propagate or transmit a program used by an instruction executing system, apparatus or device or used in conjunction with the foregoing. The program code included in the computer readable medium may be transmitted using any suitable medium, including without limitation to, an electrical wire, an optical fiber cable, RF (radio frequency), etc., or any suitable combination of the foregoing.

In some implementations, the client and the server may communicate using any network protocol that is currently known or will be developed in future, such as the hyper text transfer protocol (HTTP) and the like, and may be interconnected with digital data communication (e.g., communication network) in any form or medium. Examples of communication networks include local area networks (LANs), wide area networks (WANs), inter-networks (e.g., the Internet) and end-to-end networks (e.g., ad hoc end-to-end networks), as well as any networks that are currently known or will be developed in future.

The above computer readable medium may be included in the above-mentioned electronic device: and it may also exist alone without being assembled into the electronic device.

The computer readable medium carries one or more programs which, when executed by the electronic device, cause the electronic device to: in response to a first predetermined condition being satisfied, obtain, for a first entity associated with a first session to which a first user belongs, predetermined information of a second session associated with the first entity: and display information of the first session in an interface of the first user and display, in association, the predetermined information of the second session in the interface of the first user.

The information displaying method, apparatus and electronic device provided by the embodiments of the present disclosure, in response to a first predetermined condition being satisfied, obtains, for a first entity associated with a first session to which a first user belongs, predetermined information of a second session associated with the first entity: and displays information of the first session in an interface of the first user and displays, in association, the predetermined information of the second session in the interface of the first user. Therefore, the user, while browsing the information of the first session, can learn about the information of the second session, which helps the user to process the information of the second session as soon as possible and enhances the information interaction efficiency.

Computer program codes for carrying out operations of the present disclosure may be written in one or more programming languages, including without limitation to, an object oriented programming language such as Java, Smalltalk, C++or the like, and conventional procedural programming languages, such as the “C” programming language or similar programming languages. The program codes may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units described in the embodiments of the present disclosure may be implemented as software or hardware, wherein the name of a unit does not form any limitation to the unit per se in some case.

The functions described above may be executed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In the context of the present disclosure, the machine readable medium may be a tangible medium, which may include or store a program used by an instruction executing system, apparatus or device or used in conjunction with the foregoing. The machine readable medium may be a machine readable signal medium or a machine readable storage medium. The machine readable medium may include, but is not limited to, an electronic, magnetic, optical, electromagnetic, infrared, semiconductor system, means or device, or any suitable combination of the foregoing. More specific examples of the machine readable storage medium include the following: an electric connection with one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

The foregoing description merely illustrates the preferable embodiments of the present disclosure and used technical principles. Those skilled in the art should understand that the scope of the present disclosure is not limited to technical solutions formed by specific combinations of the foregoing technical features and also cover other technical solution formed by any combinations of the foregoing or equivalent features without departing from the concept of the present disclosure, such as a technical solution formed by replacing the foregoing features with the technical features disclosed in the present disclosure (but not limited to) with similar functions.

In addition, although various operations are depicted in a particular order, this should not be construed as requiring that these operations be performed in the particular order shown or in a sequential order. In a given environment, multitasking and parallel processing may be advantageous. Likewise, although the above discussion contains several specific implementation details, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments separately or in any suitable subcombination.

Although the subject matter has been described in language specific to structural features and/or method logical acts, it is to be understood that the subject matter defined in the appended claims is not necessarily limited to the specific features or acts described above. On the contrary, the specific features and acts described above are merely example forms of implementing the claims.

1. A method of information displaying, comprising:
in response to a first predetermined condition being satisfied, obtaining, for a first entity associated with a first session to which a first user belongs, predetermined information of a second session associated with the first entity;
displaying information of the first session in an interface of the first user; and
displaying, in association, the predetermined information of the second session in the interface of the first user.

2. The method of claim 1, wherein
the second session excludes the first session;
or
the second session comprises the first session and other sessions.

3. The method of claim 2, wherein the predetermined information of the second session comprises one or more of:
unread message-related information in the second session;
task-related information in the second session;
online document and/or offline file-related information in the second session; and
schedule-related information in the second session.

4. The method of claim 1, wherein
the second session comprises a session with a specific attribute associated with the first entity.

5. The method of claim 4, wherein the predetermined information of the second session comprises unread message-related information in the second session, and
the session with the specific attribute comprises: a session in which message notification is not turned off.

6. The method of claim 1, wherein the predetermined information of the second session comprises unread message-related information in the second session, and the unread message-related information of the second session comprises one or more of:
information indicating the total number of all unread messages in the second session;
“mention me” identification information and/or “mention all” identification information.

7. The method of claim 1, wherein
the displayed information of the first session further comprises: a first identifier indicating a subordinative relationship between the first session and the first entity.

8. The method of claim 7, wherein
the information of the first session comprises: an avatar of the first session, a name of the first session, and a name of the first entity;
the first identifier is used to characterize an association relationship between the avatar of the first session and the name of the first entity.

9. The method of claim 1, wherein the displaying the information of the first session in the interface of the first user comprises:
displaying the information of the first session in a session information display region in a session streaming region of an instant messaging client interface for the first user;
wherein name information of the first entity and the predetermined information of the second session are displayed in a first sub-region of the session information display region.

10. The method of claim 9, wherein the session streaming region of the instant messaging client interface has a plurality of session filtering tags, and
the displaying the information of the first session in the interface of the first user comprises:
in response to that a session filtering tag corresponding to a first filtering condition is selected, displaying, in the instant messaging client interface of the first user, the information of the first session in a session information display region in a session streaming region;
wherein each session filtering tag corresponds to a predetermined filtering condition, and the first session satisfies the first filtering condition.

11. The method of claim 9, further comprising:
displaying name information of the first session in a second sub-region of the session display region;
wherein the first sub-region and the second sub-region are located on different lines; or, the first sub-region and the second sub-region jointly occupy a specified number of lines and are separated by a special symbol.

12. The method of claim 1, wherein the first predetermined condition comprises:
that the first session to which the first user belongs satisfies a first specified condition;
or
that the second session satisfies a second specified condition.

13. The method of claim 12, wherein
the first specified condition comprises: a new message being received in the first session, or the first session being displayed in a session streaming region based on a user instruction;
wherein a new message being received in the first session comprises: that the first session is not excluded from the main session stream and a new message is received in the first session;
the second specified condition comprises: the predetermined information of the second session is updated.

14. The method of claim 1, further comprising:
in response to an operation of triggering the predetermined information of the second session, displaying information of one or more first entities associated with the first session in a first specified region of the interface for the first user,
wherein the information of the first entity associated with the first session comprises identification information of the first entity and information of respective sessions associated with the first entity.

15. The method of claim 1, wherein the first session is associated with more than two first entities, and
in response to a first predetermined condition being satisfied, obtaining, for a first entity associated with a first session to which a first user belongs, predetermined information of a second session associated with the first entity comprises:
in response to the first predetermined condition being satisfied, determining a target first entity from the more than two first entities, and for the target first entity, obtaining predetermined information of a second session associated with the target first entity.

16. The method of claim 15, wherein the determining a target first entity from the more than two first entities comprises:
determining at least one target first entity from the more than two first entities based on a second predetermined condition; wherein the second predetermined condition comprises one of:
that a frequency with which information of other sessions associated with the first entity is browsed by the first user is greater than a predetermined frequency threshold; and
that a message notification attribute of other sessions associated with the first entity is set to notification.

17. The method of claim 1, wherein the obtaining predetermined information of a second session associated with the first session comprises:
sending, to a server, an information obtaining request comprising an identifier of the first entity and/or an identifier of the first session;
receiving predetermined information of a second session associated with the first entity, the predetermined information of the second session sent by the server based on the information obtaining request; wherein
the server stores respective information of a plurality of sessions associated with the first entity and statistical information of the respective information of the plurality of sessions.

18. The method of claim 17, wherein information of a session comprises one or more of:
unread message-related information in the session;
task-related information in the session;
online document and/or offline file-related information in the session; and
schedule-related information in the session.

19. (canceled)

20. An electronic device, comprising:
one or more processors;
a storage device for storing one or more programs,
the one or more programs, when executed by the one or more processors, causing the one or more processors to implement acts for information displaying, comprising:
in response to a first predetermined condition being satisfied, obtaining, for a first entity associated with a first session to which a first user belongs, predetermined information of a second session associated with the first entity;
displaying information of the first session in an interface of the first user; and
displaying, in association, the predetermined information of the second session in the interface of the first user.

21. A computer readable storage medium, storing a computer program thereon, wherein the program, when executed by a processor, implements acts for information displaying, comprising:
in response to a first predetermined condition being satisfied, obtaining, for a first entity associated with a first session to which a first user belongs, predetermined information of a second session associated with the first entity:
displaying information of the first session in an interface of the first user; and
displaying, in association, the predetermined information of the second session in the interface of the first user.
